(19) United States
(12) Patent Application Publication
(10) Pub. No.: US 2015/0292979 A1
(43) Pub. Date: Oct. 15, 2015

(54) ANALYSING AND MACHINING AN OPTICAL PROFILE

(71) Applicant: Mathieu Rayer, Leicester (GB)

(72) Inventor: Mathieu Rayer, Leicester (GB)

(21) Appl. No.: 14/646,483

(22) PCT Filed: Nov. 21, 2013
(86) PCT No.: PCT/GB2013/053075

§ 371 Date: May 21, 2015

(30) Foreign Application Priority Data
Nov. 26, 2012 (GB) 1221221.3

(51) Int. Cl. G01M 11/02

(52) U.S. Cl. CPC G01M 11/0242; G01M 11/0221

(57) ABSTRACT

An apparatus for analyzing at least one measured optical profile of a machined workpiece includes an analysis module configured to: receive nominal optical profile data representing a desired profile of a workpiece as designed in a current design step; receive a plurality of measured optical profile data corresponding to a plurality of machined workpieces; for each measured optical profile data, determine a difference between the measured optical profile data and the nominal optical profile data; remove non-systematic machining errors from the determined difference, by determining an average of the plurality of determined differences; and output the determined average, corresponding to errors on the profile due to machining which are systematic machining errors, to a design module, in order to enable the design module to take into account the systematic machining errors in a further design step of the desired workpiece.

This invention relates, but is not limited, to an apparatus and method for machining an optical profile and analysing an optical profile of a machined workpiece.

Optical lenses used in objectives of cameras, multifunction peripherals or optical storage devices, such as digital versatile disc (DVD) recorders and players, are generally aspheric lenses, and have therefore surfaces having specific profiles in order to reach the desired optical specification for the objective, such as a desired Numerical Aperture (NA), a desired range and/or a desired pupil.

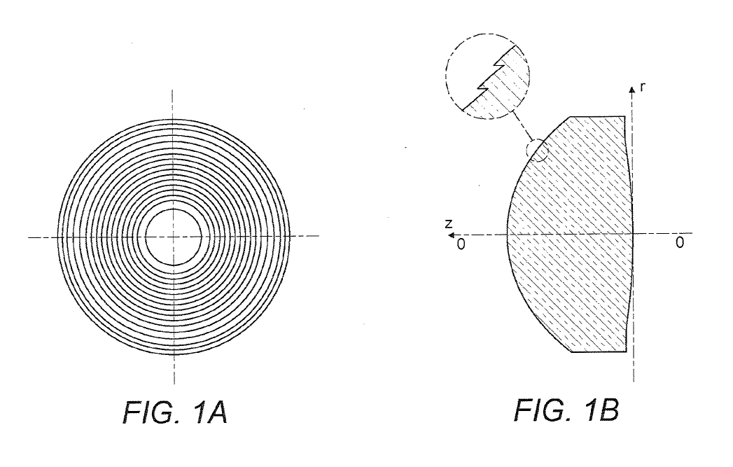

As shown in FIGS. 1A and 1B, some known aspheric lenses are composed of an aspheric refractive profile superimposed onto a diffractive lens, and are therefore called hybrid aspheric-diffractive lenses. Hybrid aspheric-diffractive lenses offer strong chromatic aberrations, typical of a diffractive lens, and a high optical quality, typical of an aspheric lens. The chromatic aberrations due to dispersion are opposite in sign to the chromatic aberrations due to diffraction, and diffractive and dispersive chromatic aberrations are thus often used to compensate each other to create an achromatic singlet.

The specific profile of the lens may be directly machined from a lens blank or block of optical material in which the lens is machined, or may be moulded in a machined mould.

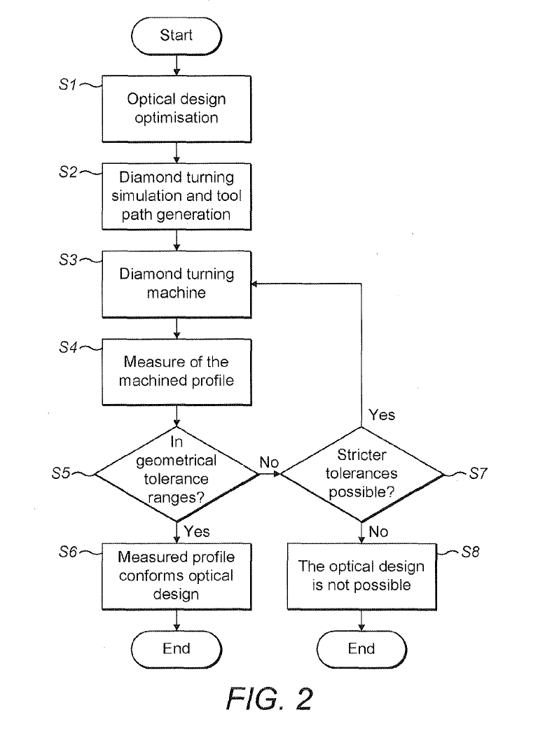

FIG. 2 shows a flow chart illustrating usual processes for designing and machining a profile of lenses or corresponding moulds, in order to reach the desired specification for the objective or lens.

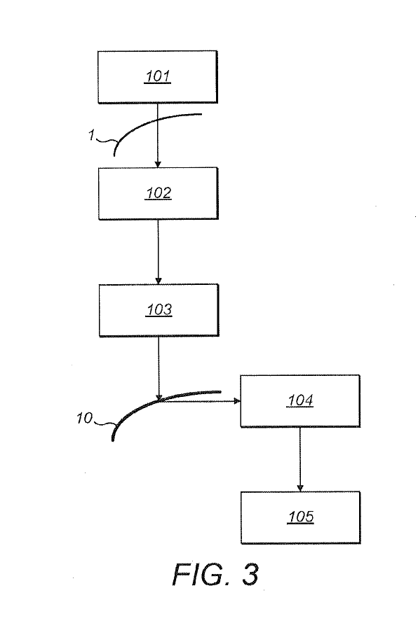

In S1, an optical design optimisation is performed, in order to determine and optimise the number of lenses and the profile of the lenses (or of the corresponding moulds). A desired profile 1 is obtained. The optical design optimisation may be performed on different dedicated software design modules 101 as shown on FIG. 3. The optical design optimisation generally comprises simulation steps, and outputs optical data.

In S2, the optical data obtained in S1 are provided as an input to a simulation module 102, for machining simulation and tool path generation. In S2 the optical data from S1 are converted into machining geometrical data which can be used by a machining machine 103, for example a Single Point Turning Machine (SPTM)—also called diamond turning machine—using a diamond tip which offers a fast and accurate way to machine the profile.

In S3, the profile is machined on the machine 103, using the machining geometrical data to obtain a machined profile 10. Generally the manufacture of hybrid diffractive lenses is difficult, since the width of the diffractive zones is typically 20 μm, the depth of the diffractive zones is less than 1 μm, and a typical profile would exhibit more than 100 diffractive zones. Therefore the transfer function of the machine 103 onto the diffractive profile—i.e. the way the machine actually machines the profile—may result in significant differences between the desired profile 1 and the machined profile 10.

In S4, the machined profile 10 is thus measured by a measurement machine 104, for example by measuring relative movement between a pivotally mounted stylus arm and the machined profile 10, along a measurement path, and by detecting, using a transducer, the deflection of the stylus arm as a tip of a stylus carried by the stylus arm follows variation in the form of the profile transverse to the measurement path. Other measurement machines 104, such as non-contact machines, could also be used.

In S5, the measurements are provided to an analysis module 105, which performs a basic profile analysis, in order to determine to which geometrical tolerance range the measurements of the profile belongs, and performs a basic optical test, in order to determine if the determined geometrical tolerance range enables the desired optical specification to be reached.

If the profile measurements are in a geometrical tolerance range which is appropriate for the desired optical specification, then it is decided in S6 that the optical design of S1 is realised, and the processes are ended.

If the profile measurements are not in an appropriate geometrical tolerance range, then in S7 it is determined if stricter geometrical tolerances are possible on the diamond turning machine 103.

If yes, then S3 is performed again, and a new profile is machined on a new workpiece, with stricter geometrical tolerances. If not, it is decided in S8 that the optical design of the desired profile 1 performed in S1 is not practically possible, using the machine 103, and the whole optical design must be completely changed and a new design cycle is necessary. It is thus understood that several cycles may be necessary in order to obtain a satisfactory machined profile 10.

It is appreciated that the above-described usual processes have drawbacks.

The optical design optimisation is performed as if the machine 103 could always machine any optimised optical desired profile 1. The design module 101 known in the art and used in Si are not designed to take into account the machining capabilities of the machine 103, such as the tool tip radius and the tool orientation. However the impact of the machining onto the diffractive profile is usually really high, since the tool tip has a radius of about 25 μm, and a diffractive zone has typically a width of 20 μm and a depth of less than 1 μm. However the output of S2, taking into account the machining capabilities, only comprises machining geometrical data, which cannot be used in S1 by the design module 101, because the software design module 101 only uses optical data.

Even in S2 the machining capabilities are only taken into account for the main profile form, i.e. the refractive part of the profile, and not for the diffractive part, which, as it is known to those skilled in the art, is much more sensitive to the machining capabilities. The transfer function of the machine 103 onto the diffractive profile usually results indeed in a significant decrease in diffraction efficiency and spherical aberration. As a result, hybrid aspheric-diffractive profiles machined during the usual processes usually suffer from high both axis and off axis aberrations and poor diffraction efficiency, which means that, most of the time, several design cycles are necessary.

Furthermore in S5 only a qualitative determination is performed, and the actual impact of the geometrical errors of the profiles on the whole design is not clear, i.e. no quantitative feedback is given which would help in the design of S1.

Moreover in S7 the contemplated correction relates only to the geometrical form of the profile, by means of stricter geometrical tolerances during the machining in S3, and the phase sensitive aspects of the design of S1 are not taken into account in the design. As a result the design process in itself is time consuming.

From a practical point of view,
the design module 101 used in S1,
the simulation module 102 used in S2 and the machine 103 used in S3, and
the measurement machine 104 used in S4 and the analysis module 105 used in S5
   are usually located at places remote from each other, and they are operated by distinct specialised operators. This means that it could take several days or weeks before a decision of redesigning a profile is made, and that the numerous cycles, including design, production and control, necessary to provide a practical design may take up to four months.

Embodiments of the present invention aim to ameliorate the above issues.

Aspects and preferred examples of the present invention are set out in the appended claims

In one aspect, there is provided an apparatus for analysing at least one measured optical profile of a machined workpiece, the apparatus comprising: an analysis module configured to:
receive nominal optical profile data representing a desired profile of a workpiece as designed in a current design step;
receive a plurality of measured optical profile data corresponding to a plurality of machined workpieces;
for each measured optical profile data, determine a difference between the measured optical profile data and the nominal optical profile data;
remove non-systematic machining errors from the determined difference, by determining an average of the plurality of determined differences; and
output the determined average, corresponding to errors on the profile due to machining which are systematic machining errors, to a design module, in order to enable the design module to take into account the systematic machining errors in a further design step of the desired workpiece.

The desired profile may be hybrid aspheric-diffractive and the nominal optical profile data may represent the desired refractive geometric profile. Determining a difference between the measured optical profile data and the nominal optical profile data may comprise:
obtaining an approximation of a systematic machining refractive error on the profile by a polynomial fit;
subtract the desired refractive geometric profile and the obtained approximation of the systematic machining refractive error from the measured profile to obtain a measured diffractive profile; and
output the obtained systematic machining refractive error and the obtained measured diffractive profile to the design module.

The expected refractive geometric profile may be described by a function z such that:

$${z}_{refr}^{theo} ( r ) = f ( r , R , κ ) + {\sum }_{i} {α}_{i} \cdot {r}^{i}$$

where the optical axis of the profile is in the z direction,
z_{refr}^{theo} is the z-component of the displacement of the profile from the vertex (r=0), at a distance r from the optical axis,
R is the radius of curvature of an axially symmetric quadric surface;
K is the conic constant of an axially symmetric quadric surface, at the vertex, and
the coefficients ai describe the deviation of the profile from the axially symmetric quadric surface specified by R and K; and
   the polynomial fit for the approximation of the systematic machining refractive error may be such that

$${ɛ}_{refr} ( r ) = {\sum }_{i = 0}^{9} {β}_{i} \cdot {r}^{i}$$

where the coefficients βi describe the deviation of the profile from the expected refractive geometric profile z as a function of r.

The coefficients βi and the corresponding coefficients αi may be taken into account by the design module in a further design step of the desired workpiece.

The measured diffractive profile may be described by a function z such that:

z_{diffr}^{meas}=z_{diffr}^{theo}(r)+ε_{diffr}(r)

where an approximation of z_{diffr}^{theo} is obtained by a polynomial fit such that:

$${z}_{diffr}^{theo} ( r ) = \{ {\sum }_{i} {γ}_{i} \cdot {r}^{i} \} mod [ t ( r ) ]$$

where the optical axis is in the z direction,
γᵢ are the polynomial coefficients of the continuous profile;
mod( ) represents the modulo operator; and
t(r) describes the thickness of the diffractive profile as a function of r, and
   where ε_{diffr}(r) is the systematic machining diffractive error.

The coefficients γᵢ may be taken into account by the design module in a further design step of the desired workpiece.

The analysis module may be configured to:
identify, in the diffractive profile, diffraction wasted zones which are inefficient for diffraction;
discard the identified wasted zones and compute an unwrapped diffractive profile;
determine the phase of the unwrapped diffractive profile for a specific diffraction mode;
compute the systematic machining diffractive phase error and the diffraction efficiency for the specific diffraction mode.

The analysis module may be configured to:
obtain an approximation of the systematic machining diffractive error by a polynomial fit such that:

$${ɛ}_{diffr} ( r ) = {\sum }_{i = 0} {ζ}_{i} \cdot {r}^{i}$$

where the coefficients ζᵢ describe the deviation of the profile from the expected diffractive profile z as a function of r; and
the coefficients ζᵢ may be taken into account by the design module in a further design step of the desired workpiece.

The analysis module may be configured to:
convert the approximation of the systematic machining diffractive error into a systematic machining diffractive phase error data Δφ_{diffr} before outputting it to the design module, such that:

$$Δ {φ}_{diffr} ( r ) = {\sum }_{i = 0} {ζ}_{i}^{′} \cdot {r}^{i} .$$

In another aspect, there is provided an apparatus for machining an optical profile of a workpiece on a machine, the apparatus comprising:

a simulation module configured to:
receive nominal optical profile data representing a desired profile of a desired workpiece as designed in an initial design step;
receive machining data corresponding to machining capabilities of the machine;
simulate a machining of the workpiece as a function of the nominal optical profile data and the machining data, to obtain a simulated profile data;
identify optical characteristics of the simulated profile data;
output the identified optical characteristics to a design module, in order to enable the design module to take into account the identified optical characteristics in a further iterative design step of the desired workpiece.

The desired profile may be hybrid aspheric-diffractive and the optical characteristics may be diffractive characteristics comprising at least one of a diffraction wasted zone, a diffraction efficiency and a systematic theoretical machining diffractive phase error.

The simulation module may be configured to:
simulate the machining of the workpiece by computing a diffractive profile;
identify, in the diffractive profile, diffraction wasted zones which are inefficient for diffraction;
discard the identified wasted zones and compute an unwrapped diffractive profile;
determine the phase of the unwrapped diffractive profile for a specific diffraction mode;
compute the systematic theoretical machining diffractive phase error and the diffraction efficiency for the specific diffraction mode.

The simulation module may be configured to:
compute the diffraction efficiency using a Fourier approach such that:

$$η = sin c ( π \cdot ( p \frac{n ( λ ) - 1}{n ( {λ}_{D} ) - 1} \cdot \frac{{λ}_{D}}{λ} - m ) )$$

where λ is the illumination wavelength, and λ_{D} is the design wavelength;
n(λ) is the refractive index of the lens at λ;
m is the diffraction mode;
p is the harmonic; and
sinc(x)=sin(x)/x.

The simulation module may be configured to:
compute the systematic theoretical simulated machining diffractive phase error Δφ_{diffr}^{simul} (r) as a polynomial fit such that:

$$Δ {ϕ}_{diffr}^{simul} ( r ) = {\sum }_{i = 0}^{9} {ξ}_{i} \cdot {r}^{i}$$

where the coefficients ζᵢ describe the deviation of the profile from the phase diffractive profile as a function of r.

The simulation module may be configured to receive output from an apparatus for analysing at least one measured optical profile of a machined workpiece and comprising an analysis module according to an aspect of the invention.

The simulation module may be configured to receive output from an apparatus for analysing at least one measured optical profile of a machined workpiece and comprising an analysis module according to an aspect of the invention, and the analysis module may be configured to:
define an approximation of the systematic non-theoretical machining diffractive phase error, such that:

$$Δ {ϕ}_{diffr}^{non - theo} ( r ) = Δ {φ}_{diffr} ( r ) - Δ {ϕ}_{diffr}^{simul} ( r ) = {\sum }_{i} {ζ}_{i}^{′} \cdot {r}^{i} - {\sum }_{i} {ξ}_{i} \cdot {r}^{i} .$$

In another aspect, there is provided methods performed on apparatuses according to aspects of the invention.

In another aspect, there is provided modules comprising a data processor, for apparatuses according to aspects of the invention.

In another aspect, there is provided a computer program product comprising program instructions to program a processor to carry out data processing of methods according to aspects of the invention or to program a processor to provide modules according to aspects of the invention.

Embodiments of the present invention facilitate the design of lenses, particularly but not only hybrid aspheric-diffractive lenses.

Embodiments of the present invention reduce the total time from concept to product, particularly by reducing the number of necessary cycles including design, production and control. The time spent on each cycle has also been reduced. Hence, the time for providing a custom machined profile is reduced, for example to less than two weeks.

Peak to Valley (P-V) or Root Mean Square (RMS) geometric tolerances are usually used to evaluate the quality of an optical profile. Embodiments of the present invention allow to tolerance an optical profile by using optical measures only, such as a Modulation Transfer Function (MTF) or a Strehl Ratio. Therefore, the tolerancing process may be made more accurate.

In some aspects, a fine metrology of the machined profile (e.g. performed on a stylus measurement apparatus) enables to identify systematic machining errors on the profile. In some aspects the fine metrology enables to study independently the diffractive and refractive profiles, and to understand quantitatively the influence of each design parameter on the optical performances of the profile.

In some aspects, the issue of decreasing radial diffraction efficiency has been mitigated by taking into account the tool shape and the tool orientation. Some aspects enable compensation of both the axis and off axis aberrations. Embodiments of the present invention also thus improve the final performances of the machined profile.

The making of custom hybrid aspheric-diffractive lenses is therefore practical.

Embodiments of the present invention will now be described, by way of example, with reference to the accompanying drawings, in which:

FIGS. 1A and 1B, already discussed, show a known aspheric lens composed of an aspheric refractive profile superimposed onto a diffractive lens;

FIG. 2, already discussed, shows a flow chart illustrating usual processes for designing and machining a profile of lenses or corresponding moulds;

FIG. 3, already discussed, shows an apparatus on which a process according to FIG. 2 is performed;

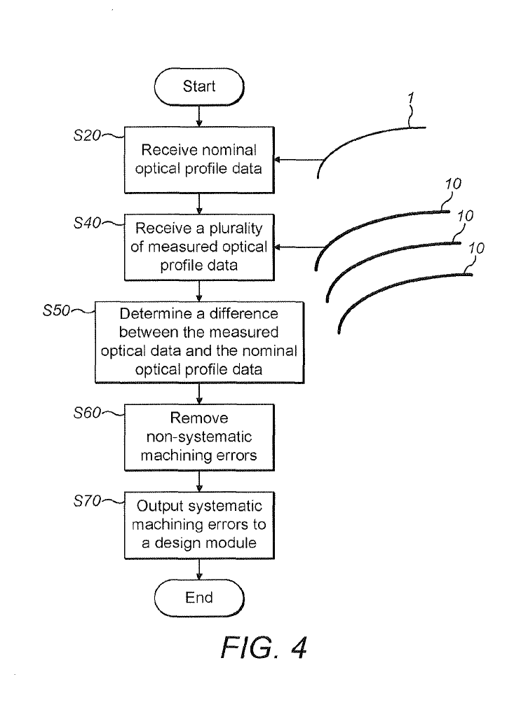

FIG. 4 shows an example of a method for analysing at least one measured optical profile of a machined workpiece according to the invention;

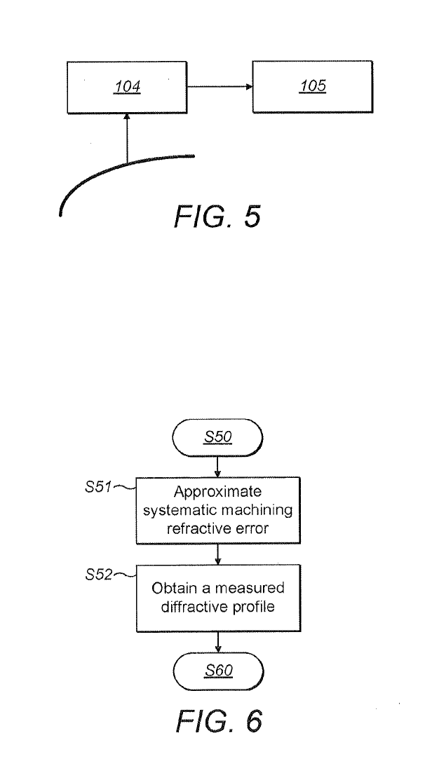

FIG. 5 shows an example apparatus on which a method of FIG. 4 is performed;

FIG. 6 schematically shows exemplary steps performed by a module of the apparatus of FIG. 5;

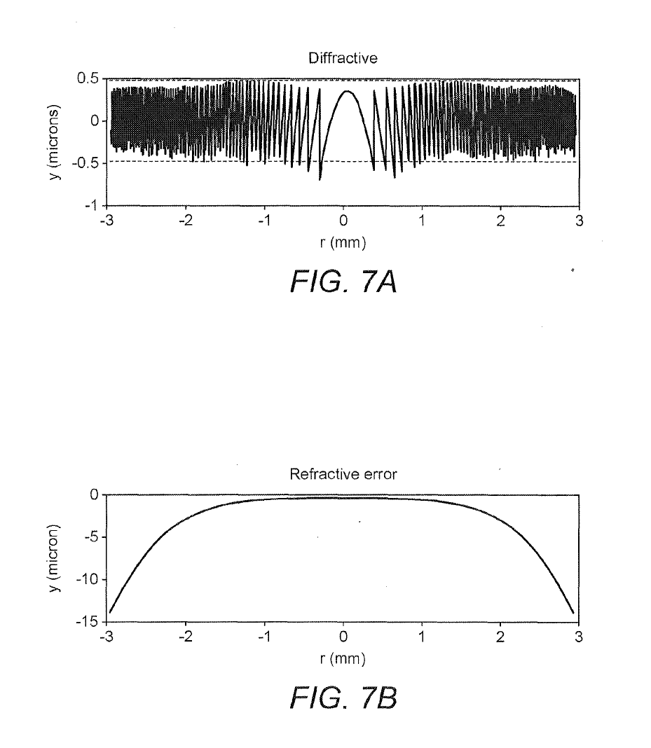

FIG. 7A shows an example of result for z_{diffr}^{measured};

FIG. 7B shows an example of result for refractive errors ε_{ref}(r);

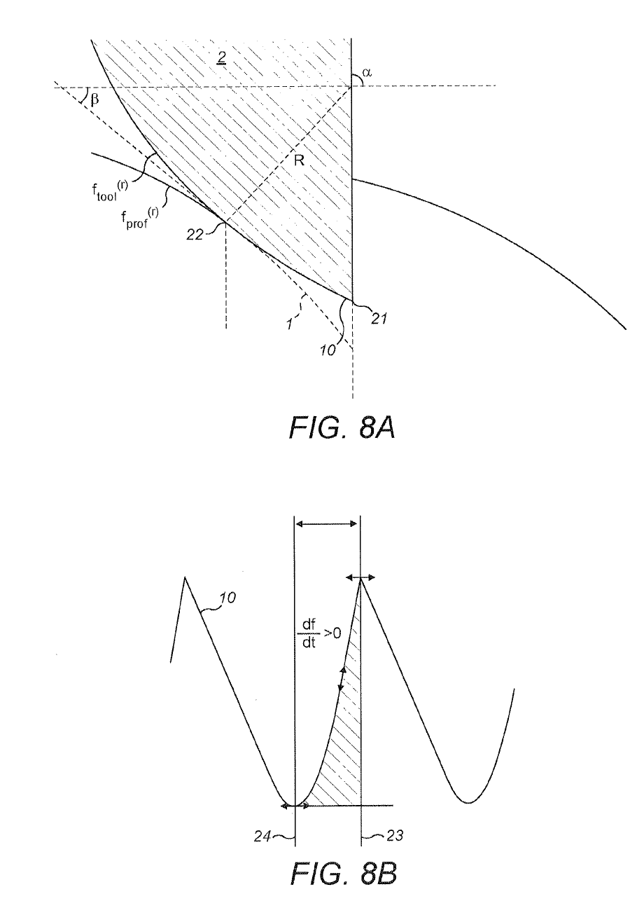

FIG. 8A shows the diamond tool path onto a desired hybrid aspheric-diffractive profile and an example of resulting diffractive error ε_{diffr}(r);

FIG. 8B shows an example of wasted zones;

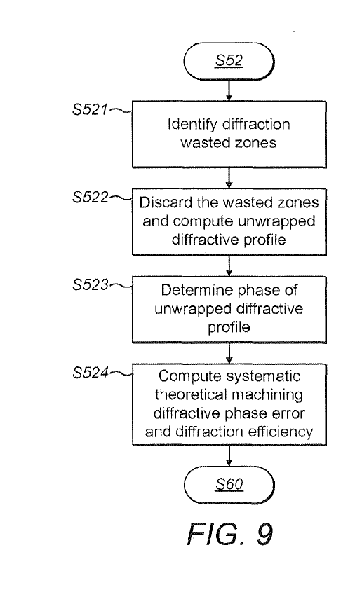

FIG. 9 schematically shows exemplary steps performed by a module of the apparatus of FIG. 5;

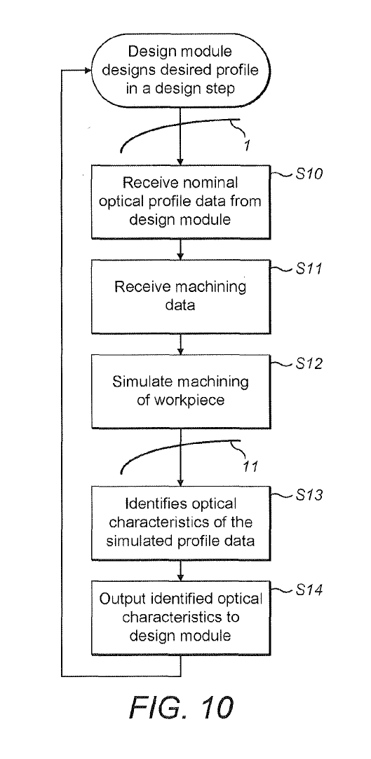

FIG. 10 shows an example of a method for machining an optical profile of a workpiece on a machine, according to the invention;

FIG. 11 shows an example apparatus on which a method of FIG. 10 is performed;

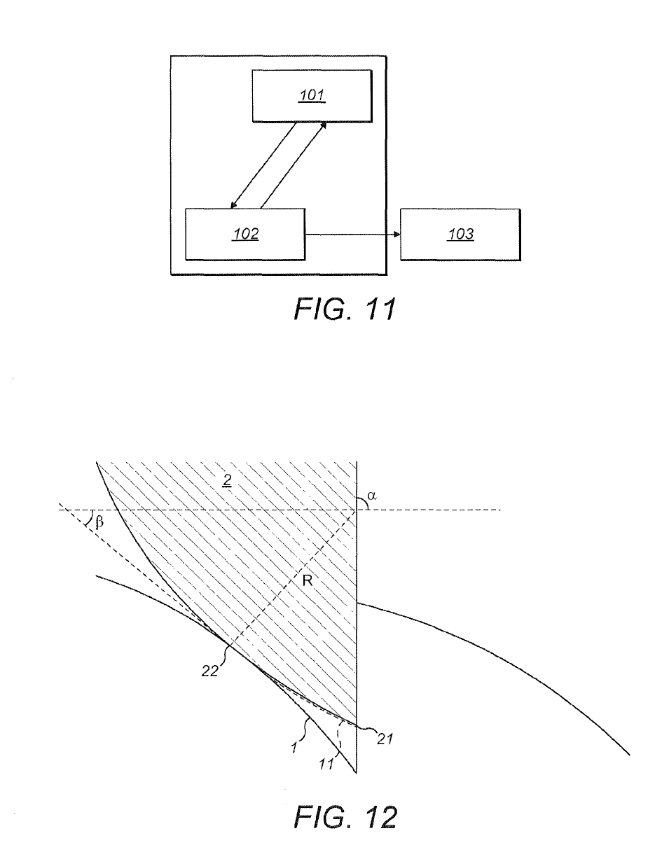

FIG. 12 shows data computed by simulating the diamond tool path onto a desired hybrid aspheric-diffractive profile;

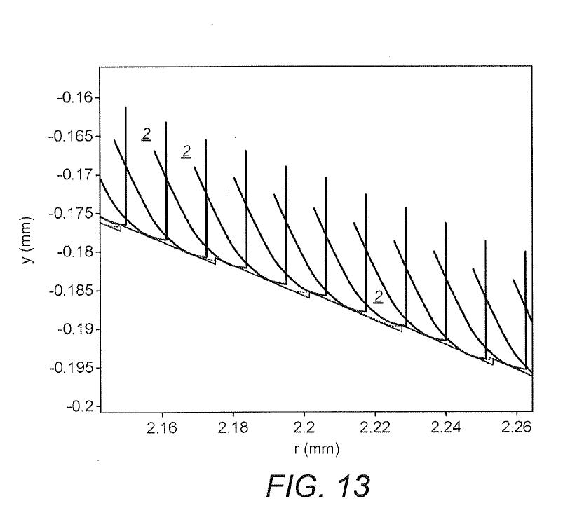

FIG. 13 shows several positions of the diamond tool onto the desired profile;

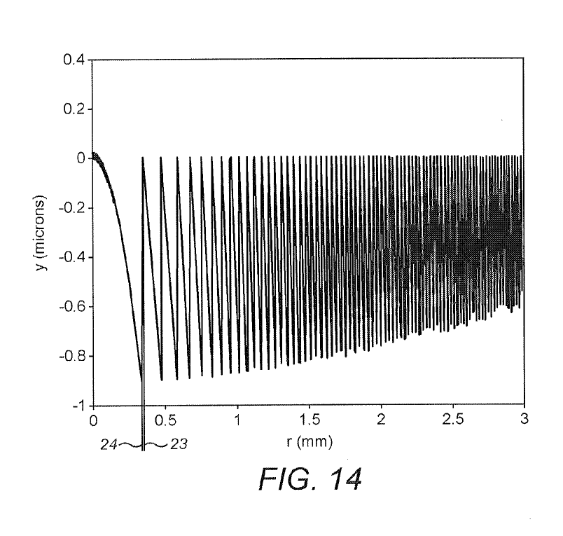

FIG. 14 shows a computed simulated diffractive profile provided by a module of the apparatus of FIG. 11;

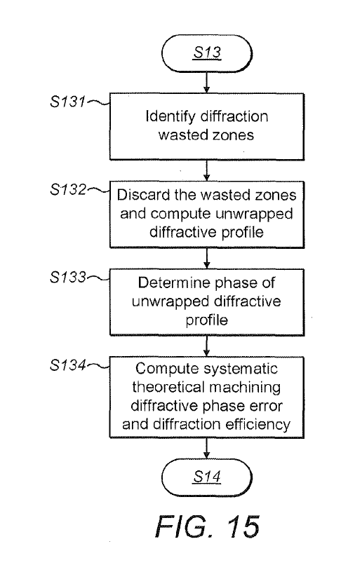

FIG. 15 schematically shows exemplary steps performed by a module of the apparatus of FIG. 11;

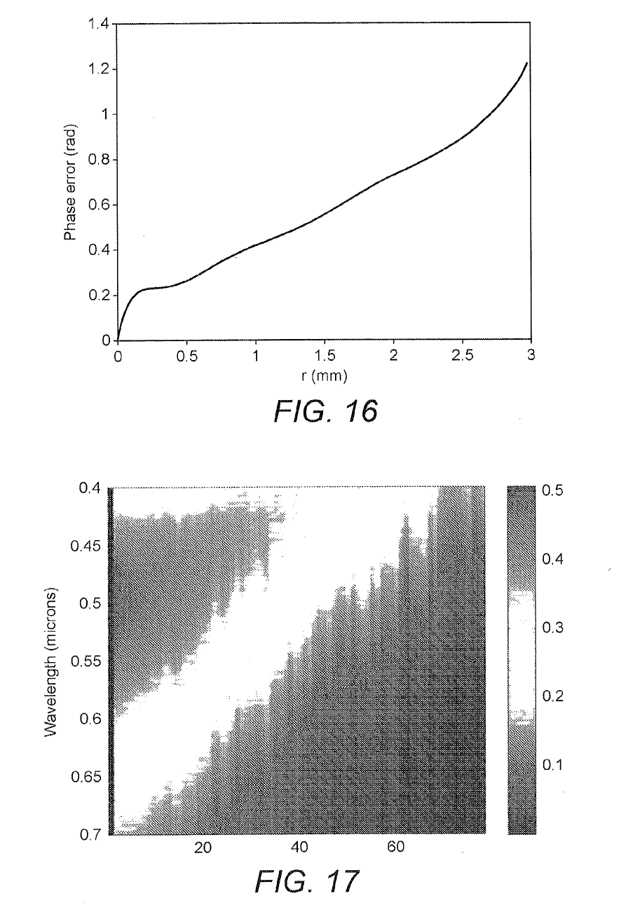

FIG. 16 shows an example of phase error;

FIG. 17 shows an example of diffraction efficiency;

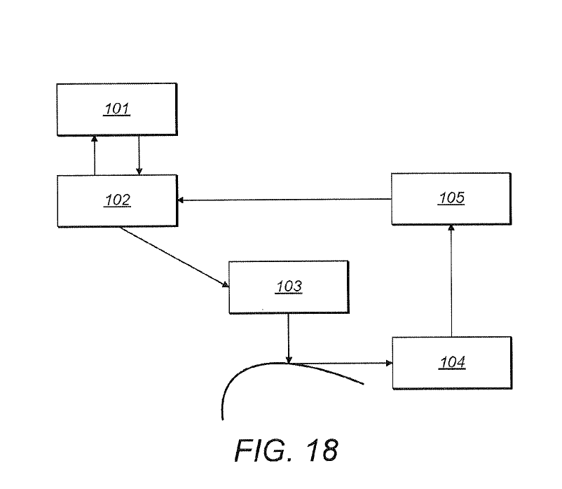

FIG. 18 shows the apparatus of FIG. 5 and the apparatus of FIG. 11 configured to work together; and

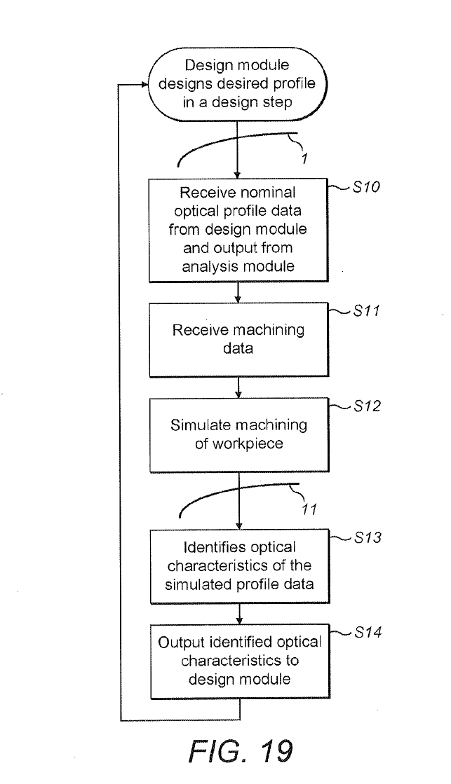

FIG. 19 shows a method comprising the simulation module of an apparatus of FIG. 11 receiving output nominal optical profile data from the design module and output from the analysis module of an apparatus of FIG. 5.

With reference to the drawings in general, it will be appreciated that similar features or elements bear identical reference signs. It will also be appreciated that the Figures are not to scale and that for example relative dimensions may have been altered in the interest of clarity in the drawings. Also any functional block diagrams are intended simply to show the functionality that exists within the device and should not be taken to imply that each block shown in the functional block diagram is necessarily a discrete or separate entity. The functionality provided by a block may be discrete or may be dispersed throughout the device or throughout a part of the device. In addition, the functionality may incorporate, where appropriate, hard-wired elements, software elements or firmware elements or any combination of these.

With reference to the detailed description below in general, it will be appreciated that it only describes in detail the specificities of aspects of the invention. Detailed description of features which may be used in some aspects of the invention but have already been described in the introductory part of the present application, is not repeated, for the sake of clarity and conciseness.

An example of a method for analysing at least one measured optical profile 10 of a machined workpiece (such as a lens or a lens mould) will now be described in reference to FIG. 4. The method is performed on an apparatus as described in reference to FIG. 5, comprising at least an analysis module 105.

With reference to FIGS. 4 and 5, it will be appreciated that a desired profile 1 of a workpiece has previously been designed in a current design step, performed by a design module, and that the nominal optical profile data representing the desired profile 1 have been sent to a simulation module to enable machining. Preferably but not necessarily, the design module uses software of the trade mark Zemax. It will be also appreciated that at least one profile 10 has been machined on a machine 103 comprising a tool 2, such as a diamond tip for example for a Single Point Turning Machine (SPTM).

In S20, the analysis module 105 receives the nominal optical profile data as designed in the current design step, e.g. from the design module.

As explained in the introductory part of the present application, the machined profile 10 is then measured by a measurement machine 104, preferably by measuring relative movement between a pivotally mounted stylus arm and the machined profile 10, along a measurement path, and by detecting, using a transducer, the deflection of the stylus arm as a tip of a stylus carried by the stylus arm follows variation in the form of the profile transverse to the measurement path. Preferably, the machined profiles 10 are measured using a stylus based surface and form metrology instruments, such as an instrument of the trade mark PGI 3D of Taylor Hobson.

In S40, the module 105 receives a plurality of measured optical profile data 10, corresponding to a plurality of machined workpieces.

The measured profile z^{measured} can be described by (E1) as follows:

z^{measured}(r, Θ)={└z_{refr}^{theo}(r, Θ)+ε_{refr}(r, Θ)+z_{diffr}^{theo}(r, Θ)+ε_{diffr}(r, Θ)┘ [symbol] Fₜₒₒₗ} [symbol] Fₘₑₐₛᵤᵣₑ(r, Θ)

where the optical axis O-O of the profile is in the z direction (as shown on FIG. 1B);
z_{refr}^{theo} is the z-component of the displacement of the desired refractive geometric profile from the vertex (r=0), at a distance r from the optical axis;
ε_{refr} is the defractive error at a distance r from the optical axis;
z_{diffr}^{theo} is the z-component of the displacement of the desired diffractive geometric profile from the vertex (r=0), at a distance r from the optical axis;
ε_{diffr} is the diffractive error at a distance r from the optical axis;
Fₜₒₒₗ is the transfer function of the machining machine;
Fₘₑₐₛᵤᵣₑ(r) is the transfer function of the measurement machine at a distance r from the optical axis;
Θ represents the angle of the polar coordinates of the vector N with respect to a unitary vector centred on the optical axis, and
[symbol] represents a morpho filteringoperator, such as convolution.

It is appreciated that the measured profile may not be axially symmetric. However in the rest of the specification, for the sake of simplicity, the functions will be functions of r only, because Θ does not impact on the equations. It is appreciated that not axially symmetric 3D surfaces may be generated by rotating the results obtained below by an angle Θ, with 0<Θ≦2π.

Equation (E1) can be further simplified by some assumptions.

Firstly, if the measurement machine is a stylus machine, then the transfer function F_{stylus}(r) is close to a

Dirac impulse, compared to the maximum frequency of the machined profile 10. This assumption is justified, since the stylus tip used is usually a 1 μm-diameter diamond sphere.

Secondly, z_{refr}^{theo} both have a low spatial frequency profile, compared to z_{diffr} ^{theo and ε}_{diffr} when convolved with Fₜₒₒₗ. This assumption is justified, since the tool is typically a hemisphere with a radius between 2 μm and 100 μm (such as 26 μm) and a diffraction ring (i.e. a diffractive zone) has a minimum spatial period of 20μm, whereas the aspheric refractive profile is smooth at the μm scale.

Hence Equation (E1) can be written as (E2) as follows:

z^{measured}(r)=z_{refr}^{theo}(r)+ε_{refr}(r)+└z_{diffr}^{theo}(r)+ε_{diffr}(r)┘ [symbol] Fₜₒₒₗ (E2)

In S50, for each measured optical profile data 10, the module 105 determines a difference between the measured optical profile data and the nominal optical profile data.

In S60, the module 105 removes non-systematic machining errors from the determined difference, by determining an average of the plurality of determined differences. These errors should not be taken into account by the design, because they are not systematic, and that is the reason why they are removed.

In S70, the module 105 outputs the determined average, corresponding to errors on the profile due to machining which are systematic machining errors (e.g. a systematic set up of the machining machine, a systematic way of operating the machine by an operator), to the design module, in order to enable the design module to take into account the systematic machining errors in a further design step of the desired workpiece. In other words, the lenses obtained by machining or moulded in a machined mould are measured experimentally by the measurement machine, and the machined profiles 10 are compared to the desired profile 1 by the module 105. The design module can therefore take into account the systematic machining errors, e.g. in the Zemax model.

An iterative design cycle including steps S20 to S70 are repeated until an adequate performance is achieved.

The invention may be applied to any type of surface, but in some examples, the desired profile 1 is hybrid aspheric-diffractive, and the nominal optical profile data preferably represents the desired refractivegeometric profile, i.e. z_{refr}^{theo} in (E2).

The refractive profile can be generally any geometric surface, such as B-spline, Zernike or Forbes asphere, but as known by those skilled in the art, a desired refractive geometric profile in a hybrid aspheric-diffractive may be described by a function z such that:

$${z}_{refr}^{theo} ( r ) = f ( r , R , κ ) + {\sum }_{i} {α}_{i} \cdot {r}^{i} \qquad ( E 3 )$$

where R is the radius of curvature of an axially symmetric quadric surface;
K is the conic constant of an axially symmetric quadric surface, at the vertex, and
the coefficients αᵢ describe the deviation of the profile from the axially symmetric quadric surface specified by R and K.

In addition, the diffractive profile of a hybrid aspheric-diffractive lens may be fitted by a generic equation, but preferably it is described by a function z such as:

$${z}_{difr}^{theo} ( r ) = \{ {\sum }_{i} {γ}_{i} \cdot {r}^{i} \} mod [ t ( r ) ] \qquad ( E6 )$$

where the optical axis is in the z direction,
γᵢ are the polynomial coefficients of the continuous profile;
mod( ) represents the modulo operator; and
t(r) describes the thickness of the diffractive profile as a function of r.

Therefore, the module 105 may in S50 subtract the desired theoretical refractive profile z_{ref}^{theo} from the measured profile z^{measured} and FIG. 6 schematically shows exemplary steps performed in S50 by the module 105.

In S51 the module 105 obtains an approximation of a systematic machining refractive error ε_{refr} on the profile. Usually, the approximation is obtained by a generic fitting, preferably by a polynomial fit. The polynomial fit for the approximation of the systematic machining refractive error is such that:

$${ɛ}_{refr} ( r ) = {\sum }_{i = 0}^{9} {β}_{i} \cdot {r}^{i}$$

where the coefficients βi describe the deviation of the profile from the desired refractive geometric profile z as a function of r. A ninth order polynomial fit works because ε_{refr} has a low frequency profile. An example of the result for ε_{refr} is shown in 7B.

In S52, the module 105 subtracts the refractive profile (i.e. the approximation consisting on the sum of the systematic machining refractive error and the desired refractive geometric profile) from the measured profile, in order to obtain a measured diffractive profile, as follows:

z_{diffr}^{measured}=z^{measured}(r)−(z_{refr}^{theo}+ε_{refr}(r)).

The result Z_{diffr}^{measured} represents the measured machined diffractive profile. An example of the result for z_{diffr}^{measured} is shown in Figure 7A (the dotted lines correspond to the theoretical diffractive thickness).

The module 105 then outputs the obtained systematic machining refractive error and the obtained measured diffractive profile to the design module 101. The coefficients βᵢ and the corresponding coefficients αᵢ (see (E3)) are taken into account by the design module in a further design step of the desired workpiece. The refractive error is preferably transmitted to a User Define Surface if the design module is of the trade mark Zemax, in order to allow the analysis of the optical performances of the profile. As added benefit, a design module of the trade mark Zemax enables an analysis of the different parameters separately.

It will be appreciated that Z_{diffr}^{measured} may be described by a function z such that:

z_{diffr}^{measured}(r)=z_{diffr}^{theo}(r)+ε_{diffr}(r) (E4)

and that, compared to a theoretical diffractive profile z_{diffr}^{theo}(r) , the shapes of the diffractive zones comprise diffractive errors ε_{diffr}(r) . The diffractive errors ε_{diffr}(r) comprise:
a trend towards a sinusoid shape at the edge profile, and
a reduction of the thickness of the diffractive zones at the edge profile.

As shown in FIG. 8A, the errors ε_{diffr}(r) are functions of
the geometry of the tool 2, more particularly the tip diameter R (e.g. R=26 μm), and
the orientation αof the tool, and
the refractive surface slope β, and
any particularity of the machine 103 which is not due to the tool 2, such as a bias axis or any systematic operation of the machine 103 by its operator.

FIG. 9 schematically shows exemplary steps performed in S52 by the module 105.

The module 105 analyses in S521 each zone, using a shape recognition algorithm This enables to measure
any jitter error on the zone position; and
the thickness of the zone.

In S521 the module 105 finds the machined surface profile by calculating the cut profile of the workpiece by the tool. This operation can be performed by a method such as morphologic closing filtering of the theoretical surface profile by the machining tool profile or another algorithm

As shown in FIG. 8A, between the points 21 and 22 the profile is described by the surface of the tool rather than the surface of the profile.

The thickness of each diffraction zone may be computed by fitting a sixth order polynomial fit onto the surface, and off-set errors due to boundary oscillation of the polynome may be suppressed by comparing the measured profile with the theoretical profile.

S521 enables identification of the diffraction wasted zones. As shown in FIG. 8B, the wasted zones are comprised between the points 23 and 24 (where f′_{profile}(r)=0), where (E5): f′_{profile}(r)>0 .

In S522, from these measured parameters, the zones are unwrapped using a numerical integration such as an Euler integration algorithm, discarding the identified wasted zones.

In S523, the module 105 determines the phase of the diffractive lenses of a specific diffraction mode.

Using (E5) an approximation of z_{diffr}^{theo} is obtained in S523 by a generic fit, preferably a polynomial fit such that:

$${z}_{difr}^{theo} ( r ) = {\sum }_{i} {γ}_{i} \cdot {r}^{i} mod [ t ( r ) ] \qquad ( E6 )$$

where the optical axis is in the z direction,
γᵢ are the polynomial coefficients of the continuous profile
mod( )represents the modulo operator; and
t(r) describes the thickness of the diffractive profile as a function of r.

In some examples, the module 105 further obtains in S523 an approximation of the systematic machining diffractive error by a generic fit, preferably a polynomial fit such that

$${ɛ}_{diffr} ( r ) = {\sum }_{i = 0} {ζ}_{i} \cdot {r}^{i}$$

where the coefficients ζᵢ describe the deviation of the profile from the expected diffractive profile z as a function of r; and
wherein the coefficients ζᵢ and the corresponding coefficients γᵢ are taken into account by the design module in a further design step of the desired workpiece.

In S524, the module 105 determines the diffraction efficiency for a specific diffraction mode, using the thicknesses of the zones and a Fourier approach.

Preferably, the module 105 computes in S524 the diffraction efficiency using a Fourier approach such that

$$η = sin c ( π \cdot ( p \frac{n ( λ ) - 1}{n ( {λ}_{D} ) - 1} \cdot \frac{{λ}_{D}}{λ} - m ) )$$

where λ is the illumination wavelength, and λ_{D} is the design wavelength;
n(λ) is the refractive index of the lens at λ;
m is the diffraction mode;
p is the harmonic; and
sinc(x)=sin(x)/x.

The module 105 then outputs the obtained diffraction efficiency and phase error, and they are transmitted to the design module 101, e.g. as a parameter into the merit function of a software module of the trade mark Zemax, and the phase error may be added to the theoretical diffractive phase by the design module 101. As added benefit, the impact of each parameter may be studied separately.

The analysis module 105 may be configured to convert the approximation of the systematic machining diffractive error into a systematic machining diffractive phase error data αφ_{diffr} before outputting it to the design module, such that:

$$Δ {φ}_{diffr} ( r ) = {\sum }_{i = 0} {ζ}_{i}^{′} \cdot {r}^{i} .$$

The output of the module 105, being optical data, can therefore be taken into account by the design module 101.

An example of a method for machining an optical profile 10 of a workpiece on a machine 103 is described in reference to FIG. 10. The method is performed on an apparatus as described in reference to FIG. 11, comprising at least a simulation module 102.

With reference to FIGS. 10 and 11, it will be appreciated that a desired profile 1 of a workpiece has been designed in an initial design step, performed by the design module 101. Preferably but not necessarily, the design module 101 uses software of the trade mark Zemax. It will be also appreciated that no profile has been machined on the intended machine 103 comprising a tool 2, such as a diamond tip for example for a Single Point Turning Machine (SPTM).

In S10, the simulation module 102 receives the nominal optical profile data representing the desired profile 1 as designed in the initial design step S1. As shown in FIG. 11, the design module 101 may be within the apparatus, or may be remote from the apparatus comprising the simulation module 102 (not shown). The simulation module may use software of the trade mark Matlab.

In S11, the module 102 receives machining data corresponding to machining capabilities of the machine 103. The machining capabilities preferably comprise at least one of the tool tip radius R and the tool orientation α.

In S12, the module 102 simulates a machining of the workpiece, as a function of the nominal optical profile data and the machining data, to obtain a simulated profile data 11.

In S13, the module 102 identifies optical characteristics of the simulated profile data 11.

In S14, the module 102 outputs the identified optical characteristics to the design module 101, in order to enable the design module 101 to take into account the identified optical characteristics in a further iterative design step S1 of the desired workpiece 1.

The invention may be applied to any type of profile, but in some examples, the desired profile 1 is hybrid aspheric-diffractive, and the optical characteristics are therefore diffractive characteristics comprising at least one of a diffraction wasted zone, a diffraction efficiency and a systematic theoretical machining diffractive phase error, but may also comprise other optical characteristics such as the MTF and/or the Strehl ratio. The diffractive characteristics resulting from the SPTM simulation (such as diffraction efficiency, phase of the diffractive profile) are therefore fed back to the design cycle.

Preferably, in S12 the simulation module 102 simulates the machining of the workpiece by computing a diffractive profile. These data are computed by simulating the diamond tool 2 path onto the desired hybrid aspheric-diffractive profile 1 as shown in FIG. 12.

In S12 the module 102 finds the machined surface profile by calculating the cut profile of the workpiece by the tool. This operation can be performed by a method such as morphologic closing filtering of the theoretical surface profile by the machining tool profile or another algorithm.

As shown in FIG. 12, between the points 21and 22 the profile is described by the surface of the tool rather than the surface of the designed profile.

In FIG. 13 the diamond tool 2 cross section is represented at several positions onto the desired profile 1. The simulated machined profile 11 is computed from the tool cross section shape and height at two consecutives radial position and is represented in dotted line.

The module 102 provides a computed simulated diffractive profile as shown in FIG. 14.

It will be appreciated that z_{diffr}^{simul} may be described by a function z such that:

z_{diffr}^{simul}(r)=z_{diffr}^{theo}(r)+Δz_{diffr}^{simul}(r) (E7)

and that compared to a theoretical diffractive profile z_{diffr}^{theo}(r), the shapes of the zone comprise theoretical simulated machining diffractive errors Δz_{diffr}^{simul}(r). The theoretical simulated machining diffractive errors comprise:
a trend towards a sinusoid shape at the edge profile, and
a reduction of the thickness of the diffractive zones at the edge profile.

As shown in FIG. 12, the theoretical simulated machining diffractive errors are functions of
the geometry of the tool 2, more particularly the tip diameter R (e.g. R=26 μm), and
the orientation α, and
the refractive surface slope β.

FIG. 15 schematically shows exemplary steps performed in S13 by the module 102.

The module 102 analyses in S131each zone, using a shape recognition algorithm This enables to measure
any jitter error on the zone position; and
the thickness of the zone.

S131 enables identification of the diffraction wasted zones, by the module 102, of diffraction wasted zones which are inefficient for diffraction, in the diffractive profile. As shown in FIG. 14, the wasted zones are comprised between the points 23 and 24 (where f′_{profile}(r)=0), where (E5):

f′_{profile}(r)>0.

In S132, the module 102 discards the identified wasted zones and computes an unwrapped diffractive profile discarding the identified wasted zones, from these measured parameters, using a numerical integration algorithm, such as an Euler integration algorithm.

In S133, the module 102 determines the phase of the unwrapped diffractive profile for a specific diffraction mode.

In S134, the module 102 computes the systematic theoretical simulated machining diffractive phase error Δφ_{diffr}^{simul}(r) and the diffraction efficiency for the specific diffraction mode.

In some examples, an approximation of z_{diffr}^{theo} is obtained in S134, for example by a generic fitting but preferably by a polynomial fit such that:

$${z}_{difr}^{theo} ( r ) = {\sum }_{i} {γ}_{i} \cdot {r}^{i} mod [ t ( r ) ] \qquad ( E6 )$$

where the optical axis is in the z direction,
γᵢ are the polynomial coefficients of the continuous profile;
mod( )represents the modulo operator; and
t(r) describes the thickness of the diffractive profile as a function of r.

In some examples, the module 102 further obtains in S134 an approximation of the theoretical simulated machining diffractive phase error Δφ_{diffr}^{simul}(r) as a generic fit, preferably a polynomial fit such that:

$${Δφ}_{diffr}^{ simul} ( r ) = {\sum }_{i = 0}^{9} {ξ}_{i} \cdot {r}^{i}$$

where the coefficients ξᵢ describe the deviation of the profile from the phase diffractive profile as a function of r.

An example of a phase error is shown in FIG. 16.

Preferably, the simulation module 102 computes in S134 the diffraction efficiency η using a Fourier approach such that:

$$η = sin c ( p π \cdot ( \frac{n ( λ ) - 1}{n ( {λ}_{D} ) - 1} \cdot \frac{{λ}_{D}}{λ} - m ) )$$

where λ is the illumination wavelength, and λ_{D} is the design wavelength;
n(λ) is the refractive index of the lens at λ;
m is the diffraction mode,
p is the harmonic; and
sinc(x)=sin(x)/x.

An example of a diffraction efficiency is shown in FIG. 17.

The module 102 then outputs the obtained diffraction efficiency and phase error, and they are transmitted to the design module 101, e.g. a module of the trade mark Zemax, in order to allow the analysis of the optical performances of the profile. In that case, the diffraction efficiency may be transferred to a module of the trade mark Zemax as a parameter into the merit function, and the phase error may be added to the theoretical diffractive phase by the design module 101. As added benefit, the impact of each parameter may be studied separately.

As shown in FIG. 18, the apparatus of FIG. 5 and the apparatus of FIG. 11 are preferably configured to work together, such that the simulation module 102 is configured to receive output from the analysis module 105.

As shown in FIG. 19, S10 now also comprises the simulation module 102 receiving output nominal optical profile data from the design module 101 and output from the analysis module 105.

In that case, it is advantageous to define an approximation of the systematic non-theoretical machining diffractive phase error (i.e. due uniquely to any particularity of the machine 103 which is not due to the tool 2), such as a bias axis of the machine 103 or any systematic operation of the machine 103 by its operator, such that:

$${Δφ}_{diffr}^{non - theo} ( r ) = {Δφ}_{diffr} ( r ) - {Δφ}_{diffr}^{simul} ( r ) = {\sum }_{i}^{ } {ζ}_{i}^{′} \cdot {r}^{i} - {\sum }_{i}^{ } {ξ}_{i} \cdot {r}^{i} .$$

The simulation module 102 can therefore take into account separately the systematic theoretical diffractive errors (due to the tool) and the systematic non-theoretical errors (due to the setting or operation of the machine), and correct them separately in a further design step.

### Modifications and Variations

As one possibility, there is provided a computer program, computer program product, or computer readable medium, comprising computer program instructions to cause a programmable computer to carry out any one or more of the methods described herein.

Various features described above may have advantages with or without other features described above.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for analysing at least one measured optical profile of a machined workpiece, the apparatus comprising:
an analysis module configured to:
receive nominal optical profile data representing a desired profile of a workpiece as designed in a current design step;
receive a plurality of measured optical profile data corresponding to a plurality of machined workpieces;
for each measured optical profile data, determine a difference between the measured optical profile data and the nominal optical profile data;
remove non-systematic machining errors from the determined difference, by determining an average of the plurality of determined differences; and
output the determined average, corresponding to errors on the profile due to machining which are systematic machining errors, to a design module, in order to enable the design module to take into account the systematic machining errors in a further design step of the desired workpiece.

2. An apparatus according to claim 1, wherein
the desired profile is hybrid aspheric-diffractive;
the nominal optical profile data represents the desired refractive geometric profile;
and wherein determining a difference between the measured optical profile data and the nominal optical profile data comprises:
obtaining an approximation of a systematic machining refractive error on the profile by a polynomial fit;
subtracting the desired refractive geometric profile and the obtained approximation of the systematic machining refractive error from the measured profile to obtain a measured diffractive profile; and
outputting the obtained systematic machining refractive error and the obtained measured diffractive profile to the design module.

3. An apparatus according to claim 2, wherein the expected refractive geometric profile is described by a function z such that:
$${z}_{refr}^{theo} ( r ) = f ( r , R , κ ) + {\sum }_{i}^{ } {α}_{i} \cdot {r}^{i}$$
where the optical axis of the profile is in the z direction,
z_{refr}^{theo} is the z-component of the displacement of the profile from the vertex (r=0), at a distance r from the optical axis,
R is the radius of curvature of an axially symmetric quadric surface;
K is the conic constant of an axially symmetric quadric surface, at the vertex, and
the coefficients αᵢ describe the deviation of the profile from the axially symmetric quadric surface specified by R and K; and
wherein the polynomial fit for the approximation of the systematic machining refractive error is such that:
$${ɛ}_{refr} ( r ) = {\sum }_{i = 0}^{9} {β}_{i} \cdot {r}^{i}$$
where the coefficients βᵢ describe the deviation of the profile from the expected refractive geometric profile z as a function of r; and
wherein the coefficients βᵢ and the corresponding coefficients ai are taken into account by the design module in a further design step of the desired workpiece.

4. An apparatus according to claim 2, wherein the measured diffractive profile is described by a function z such that:
z_{diffr}^{meas}=z_{diffr}^{theo}(r)ε_{diffr}(r)
where an approximation of z_{diffr}^{theo} is obtained by a polynomial fit such that:
$${z}_{refr}^{theo} ( r ) = \{ {\sum }_{i}^{ } {γ}_{i} \cdot {r}^{i} \} mod [ t ( r ) ]$$
where the optical axis is in the z direction,
γᵢ are the polynomial coefficients of the continuous profile;
mod( ) represents the modulo operator; and
t(r) describes the thickness of the diffractive profile as a function of r;
wherein the coefficients γᵢ are taken into account by the design module in a further design step of the desired workpiece; and
where ε_{diffr}(r) is the systematic machining diffractive error.

5. An apparatus according to claim 4, wherein the analysis module is configured to:
identify, in the diffractive profile, diffraction wasted zones which are inefficient for diffraction;
discard the identified wasted zones and compute an unwrapped diffractive profile;
determine the phase of the unwrapped diffractive profile for a specific diffraction mode;
compute the systematic machining diffractive phase error and the diffraction efficiency for the specific diffraction mode.

6. An apparatus according to claim 4, wherein the analysis module is configured to:
obtain an approximation of the systematic machining diffractive error by a polynomial fit such that:
$${ɛ}_{diffr} ( r ) = {\sum }_{i = 0}^{ } {ζ}_{i} \cdot {r}^{i}$$
where the coefficients ζᵢ describe the deviation of the profile from the expected diffractive profile z as a function of r; and
wherein the coefficients ζᵢ are taken into account by the design module in a further design step of the desired workpiece.

7. An apparatus according to claim 6, wherein the analysis module is configured to:
convert the approximation of the systematic machining diffractive error into a systematic machining diffractive phase error data Δφ_{diffr} before outputting it to the design module, such that:
$${Δφ}_{diffr} ( r ) = {\sum }_{i = 0}^{ } {ζ}_{i}^{i} \cdot {r}^{i} .$$

8. An apparatus for machining an optical profile of a workpiece on a machine, the apparatus comprising:
a simulation module configured to:
receive nominal optical profile data representing a desired profile of a desired workpiece as designed in an initial design step;
receive machining data corresponding to machining capabilities of the machine;
simulate a machining of the workpiece as a function of the nominal optical profile data and the machining data, to obtain a simulated profile data;
identify optical characteristics of the simulated profile data;
output the identified optical characteristics to a design module, in order to enable the design module to take into account the identified optical characteristics in a further iterative design step of the desired workpiece.

9. An apparatus according to claim 8, wherein
the desired profile is hybrid aspheric-diffractive and the optical characteristics are diffractive characteristics comprising at least one of a diffraction wasted zone, a diffraction efficiency and a systematic theoretical machining diffractive phase error.

10. An apparatus according to claim 9, wherein the simulation module is configured to:
simulate the machining of the workpiece by computing a diffractive profile;
identify, in the diffractive profile, diffraction wasted zones which are inefficient for diffraction;
discard the identified wasted zones and compute an unwrapped diffractive profile;
determine the phase of the unwrapped diffractive profile for a specific diffraction mode;
compute the systematic theoretical machining diffractive phase error and the diffraction efficiency for the specific diffraction mode.

11. An apparatus according to claim 10, wherein the simulation module is configured to:
compute the diffraction efficiency η using a Fourier approach such that:
$$η = sin c ( π \cdot ( p \frac{n ( λ ) - 1}{n ( {λ}_{D} ) - 1} \cdot \frac{{λ}_{D}}{λ} - m ) )$$
where λ is the illumination wavelength, and λ_{D} is the design wavelength;
n(λ) is the refractive index of the lens at λ;
m is the diffraction mode;
p is the harmonic; and
sinc(x)=sin(x)/x.

12. An apparatus according to claim 10, wherein the simulation module is configured to:
compute the systematic theoretical simulated machining diffractive phase error Δφ_{diffr}^{simul}(r) as a polynomial fit such that:
$${Δφ}_{diffr}^{ simul} ( r ) = {\sum }_{i = 0}^{9} {ξ}_{i} \cdot {r}^{i}$$
where the coefficients ξᵢ describe the deviation of the profile from the phase diffractive profile as a function of r.

13. (canceled)

14. (canceled)

15. A method for analysing at least one measured optical profile of a machined workpiece, comprising:
an analysis module:
receiving nominal optical profile data representing a desired profile of a workpiece as designed in a current design step;
receiving a plurality of measured optical profile data corresponding to a plurality of machined workpieces;
for each measured optical profile data, determining a difference between the measured optical profile data and the nominal optical profile data;
removing non-systematic machining errors from the determined difference, by determining an average of the plurality of determined differences; and
outputting the determined average, corresponding to errors on the profile due to machining which are systematic machining errors, to a design module, in order to enable the design module to take into account the systematic machining errors in a further design step of the desired workpiece.

16. The method according to claim 15, wherein
the desired profile is hybrid aspheric-diffractive;
the nominal optical profile data represents the desired refractive geometric profile;
and wherein determining a difference between the measured optical profile data and the nominal optical profile data comprises:
obtaining an approximation of a systematic machining refractive error on the profile by a polynomial fit;
subtract the desired refractive geometric profile and the obtained approximation of the systematic machining refractive error from the measured profile to obtain a measured diffractive profile; and
output the obtained systematic machining refractive error and the obtained measured diffractive profile to the design module.

17. The method according to claim 16, wherein the expected refractive geometric profile is described by a function z such that:
$${z}_{refr}^{theo} ( r ) = f ( r , R , κ ) + {\sum }_{i}^{ } {α}_{i} \cdot {r}^{i}$$
where the optical axis of the profile is in the z direction,
z_{refr}^{theo} is the z-component of the displacement of the profile from the vertex (r=0), at a distance r from the optical axis,
R is the radius of curvature of an axially symmetric quadric surface;
K is the conic constant of an axially symmetric quadric surface, at the vertex, and
the coefficients αᵢ describe the deviation of the profile from the axially symmetric quadric surface specified by R and K; and
wherein the polynomial fit for the approximation of the systematic machining refractive error is such that:
$${ɛ}_{refr} ( r ) = {\sum }_{i = 0}^{9} {β}_{i} \cdot {r}^{i}$$
where the coefficients βᵢ describe the deviation of the profile from the expected refractive geometric profile z as a function of r; and
wherein the coefficients βᵢ and the corresponding coefficients ai are taken into account by the design module in a further design step of the desired workpiece.

18. The method according to claim 16, wherein the measured diffractive profile is described by a function z such that:
z_{diffr}^{meas}=z_{diffr}^{theo}(r)+ε_{diffr}(r)
where an approximation of z_{diffr}^{theo} is obtained by a polynomial fit such that:
$${z}_{diffr}^{theo} ( r ) = {\sum }_{i}^{ } \{ {γ}_{i} \cdot {r}^{i} \} mod [ t ( r ) ]$$
where the optical axis is in the z direction,
γᵢ are the polynomial coefficients of the continuous profile;
mod( ) represents the modulo operator; and
t(r) describes the thickness of the diffractive profile as a function of r;
wherein the coefficients γᵢ are taken into account by the design module in a further design step of the desired workpiece; and
where ε_{diffr}(r) is the systematic machining diffractive error.

19. The method according to claim 18, comprising the analysis module:
identifying, in the diffractive profile, diffraction wasted zones which are inefficient for diffraction;
discarding the identified wasted zones and compute an unwrapped diffractive profile;
determining the phase of the unwrapped diffractive profile for a specific diffraction mode;
computing the systematic machining diffractive phase error and the diffraction efficiency for the specific diffraction mode.

20. The method according to claim 18, comprising the analysis module:
obtaining an approximation of the systematic machining diffractive error by a polynomial fit such that:
$${ɛ}_{diffr} ( r ) = {\sum }_{i = 0} {ζ}_{i} \cdot {r}^{i}$$
where the coefficients ζᵢ describe the deviation of the profile from the expected diffractive profile z as a function of r; and
wherein the coefficients ζᵢ are taken into account by the design module in a further design step of the desired workpiece.

21. The method according to claim 20, comprising the analysis module:
converting the approximation of the systematic machining diffractive error into a systematic machining diffractive phase error data Δφ_{diffr} before outputting it to the design module, such that:
$${Δφ}_{diffr} ( r ) = {\sum }_{i = 0}^{ } {ζ}_{i}^{′} \cdot {r}^{i} .$$

22. The method according to claim 15, further comprising, in a method for machining an optical profile of a workpiece on a machine, the analysis module sending output to a simulation module, the method for machining the optical profile comprising:
the simulation module:
receiving nominal optical profile data representing a desired profile of a desired workpiece as designed in an initial design step;
receiving machining data corresponding to machining capabilities of the machine;
simulating a machining of the workpiece as a function of the nominal optical profile data and the machining data, to obtain a simulated profile data;
identifying optical characteristics of the simulated profile data;
outputting the identified optical characteristics to a design module, in order to enable the design module to take into account the identified optical characteristics in a further iterative design step of the desired workpiece.

23-36. (canceled)
